(19) United States
(12) Patent Application Publication
(10) Pub. No.: US 2026/0337073 A1
(43) Pub. Date: Oct. 29, 2026

(54) ORGANIC WASTEWATER TREATMENT METHOD AND ORGANIC WASTEWATER TREATMENT APPARATUS

(71) Applicant: KUBOTA CORPORATION, Osaka-shi, Osaka (JP)

(72) Inventors: Soichiro YATSUGI, Amagasaki-shi (JP); Shinya NAGAE, Amagasaki-shi (JP); Yuko TSUZUKI, Amagasaki-shi (JP)

(73) Assignee: KUBOTA CORPORATION, Osaka-shi, Osaka (JP)

(21) Appl. No.: 19/115,963

(22) PCT Filed: Sep. 14, 2023
(86) PCT No.: PCT/JP2023/033483

§ 371 Date: Mar. 27, 2025

(30) Foreign Application Priority Data
Oct. 11, 2022 (JP) 2022-162943

(51) Int. Cl. C02F 3/28; C02F 3/00; C02F 3/12; C02F 3/30

(52) U.S. Cl. CPC C02F 3/2866; C02F 3/006; C02F 3/1273; C02F 3/302; C02F 2209/04; C02F 2209/16; C02F 2301/046

(57) ABSTRACT

An organic wastewater treatment method for biologically treating organic wastewater containing nitrogen in activated sludge. The method includes switching an operating state of a stirring mechanism in an anoxic tank of an organic wastewater treatment apparatus to cause the anoxic tank to temporarily function as an anaerobic tank. The organic wastewater treatment apparatus includes: the anoxic tank including the stirring mechanism, the stirring mechanism being configured to stir supplied raw water and activated sludge; an aerobic tank including a membrane separator immersed in activated sludge; and a sludge return path configured to return activated sludge from the aerobic tank to the anoxic tank. The method thus prevents the development of actinomycetes without increasing equipment costs.

### TECHNICAL FIELD

The present invention relates to an organic wastewater treatment method and an organic wastewater treatment apparatus.

### Background Art

Widely accepted conventional methods for biologically treating organic wastewater containing nitrogen and phosphorus, e.g., sewage, using activated sludge include A2O methods (UCT methods), in which an anaerobic tank, an anoxic tank, and an aerobic tank are arranged in this order to supply sludge in the aerobic tank to the anaerobic and anoxic tanks in a circulating manner. Recent focus has been on MBR methods (e.g., UCT-MBR), in which, as shown in FIGS. 6A and 6B, membrane separators 4 are immersed in an aerobic tank 3 in place of a settlement tank for solid-liquid separation, and an air-lift sludge return path 5 is provided to return part of activated sludge from the aerobic tank 3 to an anoxic tank 2 and an anaerobic tank 1.

Patent Literature 1 discloses a method for inhibiting foaming scum. For sewage treatment facilities that use any conventional activated sludge process where sewage is retained in an aeration tank for 24 hours or more, such as oxidation ditch and extended aeration processes, the disclosed method sets the aerobic sludge retention time in the system to 15 days or less to thereby inhibit the occurrence of foaming scum caused by actinomycetes as causative microorganisms.

Noting the fact that actinomycetes are aerobic bacteria, the disclosed method provides anaerobic time periods or anaerobic zones in an aeration tank to reduce the time in which actinomycetes can grow, thereby reducing the amount of actinomycetes grown even with a long sludge retention time.

### Citation List

### Patent Literature

Patent Literature 1: Japanese Unexamined Patent Application Publication No. 08-309383

### SUMMARY OF INVENTION

### Technical Problem

In the MBR methods described above, it is common to regulate the mixed liquor suspended solids (hereinafter referred to as “MLSS”) [mg/liter] to be 7,000 to 10,000 [mg/liter], so that the sludge retention time (hereinafter referred to as “SRT”) tends to be long. Additionally, aeration for cleaning, which is essential to avoid membrane clogging in membrane separators, often makes the dissolved oxygen concentration (hereafter referred to as “DO concentration”) in the aerobic tank remain high. These factors create an environment in which actinomycetes can easily develop.

When actinomycetes develop and a large amount of scum accumulates near the water surface, a problem arises in which pump flow of the air-lift pump provided in the sludge return path is blocked, inhibiting the return of activated sludge from the aerobic tank to the anoxic tank. Another possible problem is the outflow of foam scum from the aerobic tank to the outside, potentially leading to false detection of sensors provided in the aerobic tank and other locations.

Once actinomycetes have occurred, one may contemplate addressing the situation by physically removing scum, completely replacing sludge, or shortening the SRT. However, physically removing scum is very complicated work for large-scale facilities, and replacing sludge and shortening the SRT are also not easy to accomplish. Thus, the reality is that there is no choice but to continue the operation without being able to inhibit the actinomycetes.

One key to inhibiting the development of such actinomycetes is to reduce the amount of easily decomposable organic matters flowing into the aerobic tank. In the UCT-MBR process described above, a method for facilitating consumption of easily decomposable organic matters by polyphosphate-accumulating organisms in the anaerobic tank, in addition to facilitating denitrification reactions in the anoxic tank, has been in practical use. Polyphosphate-accumulating organisms have the property of taking up organic matters, such as acetic acid and butyric acid, and releasing phosphoric acid as polyphosphate under anaerobic conditions during the process of accumulating intracellular reserve substances, and absorbing more phosphoric acid as polyphosphate under aerobic conditions than they released.

In this case, it is required to install an anaerobic tank in addition to the anoxic tank, so that a large facility area is required. It is also required to install a stirrer in each of the anoxic and anaerobic tanks and install a sludge return path from the anoxic tank to the anaerobic tank, leading to increased equipment costs.

By the way, actinomycetes are more likely to develop when the SRT is longer due to a low inflow load and resultant reduced generation of excess sludge. Thus, even in a two-tank MBR system consisting of an aerobic tank and an anoxic tank, in view of the reduced capacity required for the anoxic tank, excess space in the anoxic tank can be repurposed as an anaerobic tank to help inhibit actinomycetes. However, such design to allow for division into anaerobic and anoxic tanks leads to increased equipment costs as with the above case, and so this is a relatively expensive measure for inhibiting actinomycetes.

It is an object of the present invention to provide an organic wastewater treatment method and an organic wastewater treatment apparatus that can effectively prevent the development of actinomycetes in organic wastewater containing nitrogen without increasing equipment costs.

### Solution to Problem

To achieve the above object, an organic wastewater treatment method for biologically treating organic wastewater containing nitrogen in activated sludge is provided according to the present invention. As a first feature of the method, the method includes switching an operating state of a stirring mechanism in an anoxic tank of an organic wastewater treatment apparatus to cause the anoxic tank to temporarily function as an anaerobic tank. The organic wastewater treatment apparatus includes: the anoxic tank including the stirring mechanism, the stirring mechanism being configured to stir supplied raw water and activated sludge; an aerobic tank including a membrane separator immersed in activated sludge; and a sludge return path configured to return activated sludge from the aerobic tank to the anoxic tank.

During a process in which nitrate nitrogen returned from the sludge return path comes into contact with and is denitrified by denitrifying bacteria in activated sludge as the stirring mechanism in the anoxic tank operates, easily decomposable organic matters contained in raw water are consumed by the denitrifying bacteria. When the operating state of the stirring mechanism is switched, e.g., when it is stopped operating, nitrate nitrogen contained in sludge returned from the sludge return path comes into contact with and is denitrified by the denitrifying bacteria during spontaneous settling of the sludge in the tank, eventually resulting in the activated sludge becoming highly anaerobic with no nitrate nitrogen present in it. Under highly anaerobic conditions, easily decomposable organic matters contained in the raw water are taken up by polyphosphate-accumulating organisms, resulting in phosphorus being released as polyphosphate. In this manner, after the easily decomposable organic matters contained in the raw water have been consumed by the polyphosphate-accumulating organisms, the sludge is supplied to the aerobic tank. This inhibits the development of actinomycetes even in the aerobic tank with a high DO concentration. This at the same time provides a phosphorus removal effect through excessive uptake by the polyphosphate-accumulating organisms.

In addition to the first feature above, the method has a second feature that the method further includes adjusting a period in which the anoxic tank is caused to temporarily function as the anaerobic tank, using any of an oxidation-reduction potential, a T-N concentration, or an MLSS as an indicator.

With the anoxic tank temporarily functioning as an anaerobic tank, if the potential detected by an oxidation-reduction potential sensor in the anoxic tank starts to deviate from the range where denitrification reactions occur, a T-N concentration sensor detects an increase in T-N concentration in the treated water, or the MLSS value detected by an MLSS sensor in the aerobic tank increases, the anoxic tank is switched from temporarily functioning as an anaerobic tank to activating the stirring mechanism to facilitate the denitrification process. This prevents an increase in T-N concentration in the treated water.

An organic wastewater treatment apparatus for biologically treating organic wastewater containing nitrogen in activated sludge is also provided according to the present invention. As a first feature of the apparatus, the apparatus includes: an anoxic tank including a stirring mechanism, the stirring mechanism being configured to stir raw water and activated sludge; an aerobic tank including a membrane separator immersed in activated sludge; a sludge return path configured to return activated sludge from the aerobic tank to the anoxic tank; and a control unit configured to switch an operating state of the stirring mechanism to cause the anoxic tank to temporarily function as an anaerobic tank.

The control unit switches the operating state of the stirring mechanism to cause the anoxic tank, where the denitrification process takes place, to function as an anaerobic tank, thereby causing easily decomposable organic matters in the raw water to be consumed by the polyphosphate-accumulating organisms. This can reduce the amount of easily decomposable organic matters flowing into the aerobic tank and thus inhibit the development of actinomycetes in the aerobic tank.

In addition to the first feature above, the apparatus has a second feature that a raw water supply mechanism for supplying raw water to the anoxic tank is configured to supply raw water to near a bottom of the anoxic tank, and the sludge return path is configured to return sludge from the aerobic tank to near a water surface of the anoxic tank.

With the anoxic tank temporarily functioning as an anaerobic tank, the raw water supplied to near the bottom of the anoxic tank by the raw water supply mechanism rises in the tank and is gently mixed over time with the sludge, returned from the sludge return path to near the water surface of the anoxic tank, as the sludge settles in the tank. During this settling of the sludge to the bottom of the anoxic tank, nitrate nitrogen disappears from the water to be treated around the sludge. This makes the sludge more anaerobic, and the easily decomposable organic matters are consumed as the polyphosphate-accumulating organisms take up organic acids contained in the raw water supplied from the lower portion of the anoxic tank.

In addition to the second feature above, the apparatus has a third feature that a communication portion configured to allow activated sludge to flow down from the anoxic tank to the aerobic tank is located near the water surface of the anoxic tank.

The communication portion is located near the water surface of the anoxic tank, which prevents the sewage supplied to near the bottom of the anoxic tank from taking a shortcut into the aerobic tank. In addition, the sludge returned to the anoxic tank settles and only the supernatant flows into the aerobic tank via the communication portion, which helps increase the MLSS concentration in the anoxic tank and thus the anaerobic degree therein.

In addition to the third feature above, the apparatus has a fourth feature that the control unit is configured to adjust a period in which the anoxic tank is caused to temporarily function as the anaerobic tank, using any of an oxidation-reduction potential, a T-N concentration, or an MLSS as an indicator.

The control unit causes the anoxic tank to temporarily function as an anaerobic tank and then switches it to function as an anoxic tank, using any of an oxidation-reduction potential, a T-N concentration, or an MLSS as an indicator. This can inhibit the development of actinomycetes in the aerobic tank while avoiding an increase in T-N concentration in the treated water beyond the allowable range.

In addition to the fourth feature above, the apparatus has a fifth feature that a potential sensor configured to measure the oxidation-reduction potential is located at a boundary between anoxic and anaerobic regions in the anoxic tank, the boundary being created when the anoxic tank is caused to temporarily function as the anaerobic tank.

If the oxidation-reduction potential detected at the boundary between the anoxic and anaerobic regions has started to increase extremely, it is suspected that the ascending speed of water mass due to the supply of sewage has completely exceeded the settling speed of the activated sludge. Hence, the anoxic tank is returned to its normal operation state to mix the sewage and activated sludge. This ensures nitrogen removal performance and makes it possible to address any worsening of T-N concentration in the treated water before it happens.

### Advantageous Effects of Invention

As described above, the present invention can provide an organic wastewater treatment method and an organic wastewater treatment apparatus that can effectively prevent the development of actinomycetes in organic wastewater containing nitrogen without increasing equipment costs.

### BRIEF DESCRIPTION OF DRAWINGS

FIG. 1A depicts an embodiment of the organic wastewater treatment apparatus according to the present invention, illustrating a plan view of the apparatus when an anoxic tank is in a normal operating state, FIG. 1B illustrates a front view of the apparatus when the anoxic tank is in a normal operating state, FIG. 1C illustrates a plan view of the apparatus when the anoxic tank is in an anaerobic operating state, and FIG. 1D illustrates a front view of the apparatus when the anoxic tank is in an anaerobic operating state.

FIG. 2 illustrates a separation membrane contained in a membrane separator.

FIG. 3A depicts another embodiment of the organic wastewater treatment apparatus according to the present invention, illustrating a plan view of the apparatus when the anoxic tank is in a normal operating state, FIG. 3B illustrates a front view of the apparatus when the anoxic tank is in a normal operating state, FIG. 3C illustrates a plan view of the apparatus when the anoxic tank is in an anaerobic operating state, and FIG. 3D illustrates a front view of the apparatus when the anoxic tank is in an anaerobic operating state.

FIG. 4A depicts still another embodiment of the organic wastewater treatment apparatus according to the present invention, illustrating a plan view of the apparatus when the anoxic tank is in a normal operating state, FIG. 4B illustrates a front view of the apparatus when the anoxic tank is in a normal operating state, FIG. 4C illustrates a plan view of the apparatus when the anoxic tank is in an anaerobic operating state, and FIG. 4D illustrates a front view of the apparatus when the anoxic tank is in an anaerobic operating state.

FIG. 5A depicts yet still another embodiment of the organic wastewater treatment apparatus according to the present invention, illustrating a front view of the apparatus when the anoxic tank is in a normal operating state, and FIG. 5B illustrates a front view of the apparatus when the anoxic tank is in an anaerobic operating state.

FIG. 6A illustrates a conventional MBR-type organic wastewater treatment apparatus including anoxic and aerobic tanks, and FIG. 6B illustrates a conventional MBR-type organic wastewater treatment apparatus including anaerobic, anoxic, and aerobic tanks.

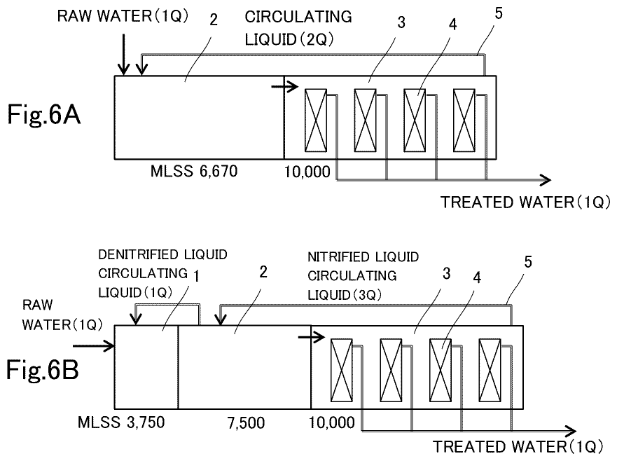

### DESCRIPTION OF EMBODIMENTS

Hereinafter, embodiments of the wastewater treatment method and the wastewater treatment apparatus according to the present invention are described with reference to the drawings. The wastewater treatment apparatus according to the present invention is an organic wastewater treatment apparatus to biologically treat organic wastewater containing nitrogen and phosphorus, e.g., sewage, in activated sludge.

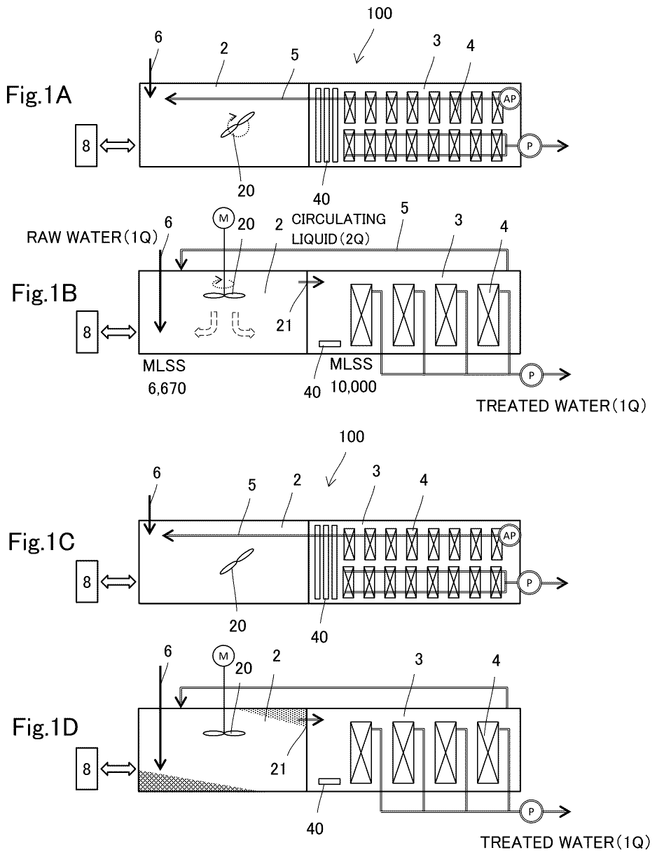

FIGS. 1A and 1B illustrate an organic wastewater treatment apparatus 100. The organic wastewater treatment apparatus 100 includes, among others, an anoxic tank 2 with a stirring mechanism 20, an aerobic tank 3 in which membrane separators 4 are immersed, a sludge return path 5 to return sludge from the aerobic tank 3 to the anoxic tank 2, a raw water supply mechanism 6 to supply raw water, which is organic wastewater containing nitrogen and phosphorus, to the anoxic tank 2, and a control unit 8.

The raw water supply mechanism 6 is disposed at one side of the anoxic tank 2 and configured with a raw water supply pipe with an opening formed near the bottom of the anoxic tank 2. The sludge return path 5 is configured with an air-lift pump AP located downstream of the aerobic tank 3 and a sludge transport pipe to transport sludge pumped by the air-lift pump AP. The sludge return path 5 is disposed such that the opening of the sludge transport pipe is located near the water surface of the anoxic tank 2.

The stirring mechanism 20 includes stirring blades located at the center of the anoxic tank 2 in plan view and a motor M to rotate the stirring blades. When the motor M is driven in a forward direction, the stirring blades create a downflow of the sludge and raw water in the tank, and when it reaches the bottom, a circulating flow is created around the bottom that turns into an upflow.

Multiple tiers of membrane separators 4 are immersed in the aerobic tank 3. Treated water having permeated separation membranes in each membrane separator 4 is pumped out by a suction pump P through a water collecting pipe and a header pipe.

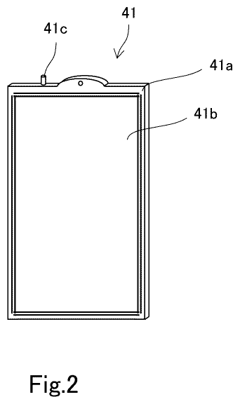

Multiple membrane elements 41 are incorporated in each membrane separator 4. As shown in FIG. 2, the membrane element 41 is configured with a resin membrane support 41a with a water collecting pipe 41c at the top thereof and separation membranes 41b on both front and back sides thereof. In the present embodiment, the separation membrane 41b is a microfiltration membrane with a nominal pore size of about 0.4 um that includes a porous organic polymer membrane on a nonwoven fabric surface.

The type of the separation membrane 41b and the membrane element 41 are not limited to those described above, and any type of separation membrane and any form of membrane element (hollow fiber membrane elements, tubular membrane elements, monolith membrane elements, etc.) may be used.

An air diffuser is disposed below the membrane separators 4. The surface of each separation membrane 41b is cleaned by the upflow of air bubbles supplied from the air diffuser and rising inside the tank. In addition, an auxiliary air diffuser 40 is disposed in the aerobic tank 3 upstream of the region where the membrane separators 4 are immersed.

The raw water supplied from the raw water supply mechanism 6 to the anoxic tank 2 flows down to the aerobic tank together with activated sludge via a communication portion 21. An opening formed near the water surface of the anoxic tank 2 in a partition wall separating the anoxic tank 2 and the aerobic tank 3 serves as the communication portion 21.

In the aerobic tank 3, ammoniac nitrogen in the raw water is nitrified by nitritating bacteria and nitrifying bacteria into nitrate nitrogen under aerobic conditions regulated by the auxiliary air diffuser 40. The nitrate nitrogen is sent to the anoxic tank 2 together with activated sludge via the sludge return path 5 and denitrified by denitrifying bacteria in the anoxic tank 2. In the present embodiment, the treated water 1Q is extracted through the membrane separators 4 relative to the raw water 1Q flowing into the anoxic tank 2, and the return amount is set such that the flow rate 2Q is circulated via the sludge return path 5. The MLSS concentration in the anoxic tank 2 is set to 6,670 [mg/liter], and the MLSS concentration in the aerobic tank 3 is set to 10,000 [mg/liter].

As shown in FIGS. 1C and 1D, the control unit 8 switches the operating state of the stirring mechanism 20 in the anoxic tank 2 to cause the anoxic tank 2 to temporarily function as an anaerobic tank. Thereafter, the control unit 8 controls the stirring mechanism 20 to return to its original operating state to thereby allow the anoxic tank 2 to resume its normal state from functioning as an anaerobic tank, based on any of the output from a potential sensor provided in the anoxic tank 2 to measure the oxidation-reduction potential, the output from an MLSS concentration sensor provided in the aerobic tank 3, or the T-N concentration in the treated water detected by a T-N concentration sensor.

During a normal treatment process, in which nitrate nitrogen returned from the sludge return path 5 comes into contact with and is denitrified by the denitrifying bacteria in the activated sludge as the stirring mechanism 20 in the anoxic tank 2 operates, easily decomposable organic matters contained in the raw water are consumed by the denitrifying bacteria.

When the operating state of the stirring mechanism 20 is switched, e.g., when it is stopped operating, the nitrate nitrogen contained in the sludge returned from the sludge return path 5 comes into contact with and is denitrified by the denitrifying bacteria during spontaneous settling of the sludge in the tank, eventually resulting in the activated sludge becoming highly anaerobic, with no nitrate nitrogen present in it. Under highly anaerobic conditions, easily decomposable organic matters contained in the raw water, such as acetic acid and butyric acid, are taken up by polyphosphate-accumulating organisms, resulting in phosphorus being released as polyphosphate.

In this manner, after the easily decomposable organic matters contained in the raw water have been consumed by the polyphosphate-accumulating organisms, the sludge is supplied to the aerobic tank. This inhibits the development of actinomycetes even in the aerobic tank 3 with a high DO concentration. This at the same time provides a phosphorus removal effect through excessive uptake by the polyphosphate-accumulating organisms.

In more detail, the raw water supply mechanism 6 is configured to supply raw water to near the bottom of the anoxic tank 2, and the sludge return path 5 is configured to return the sludge from the aerobic tank 3 to near the water surface of the anoxic tank 2. Hence, with the anoxic tank 2 temporarily functioning as an anaerobic tank, i.e., with the stirring mechanism 20 stopped, the raw water supplied to near the bottom of the anoxic tank 2 by the raw water supply mechanism 6 rises in the tank and is gently mixed over time with the sludge, returned from the sludge return path 5 to near the water surface of the anoxic tank 2, as the sludge settles in the tank. During this settling of the sludge to the bottom of the anoxic tank 2, nitrate nitrogen disappears from the water to be treated around the sludge. This makes the sludge more anaerobic, and the easily decomposable organic matters are consumed as the polyphosphate-accumulating organisms take up organic acids contained in the raw water supplied from the lower portion of the anoxic tank.

The communication portion 21 is located near the water surface of the anoxic tank 2, which prevents the raw water supplied to near the bottom of the anoxic tank 2 from taking a shortcut into the aerobic tank 3. In addition, the sludge returned to the anoxic tank 2 settles and only the supernatant flows into the aerobic tank 3 via the communication portion 21, which helps increase the MLSS concentration in the anoxic tank 2 and thus the anaerobic degree therein.

With the anoxic tank 2 temporarily functioning as an anaerobic tank, if the potential detected by an oxidation-reduction potential sensor in the anoxic tank 2 starts to deviate from the range where denitrification reactions occur, a T-N concentration sensor detects an increase in T-N concentration in the treated water, or the MLSS value detected by an MLSS sensor in the aerobic tank 3 increases, the anoxic tank 2 is switched from temporarily functioning as an anaerobic tank to activating the stirring mechanism 20 to facilitate the denitrification process. This prevents an increase in T-N concentration in the treated water.

In the case of using an oxidation-reduction potential sensor, the sensor is preferably installed at the boundary depth between anoxic and anaerobic regions that is formed in the anoxic tank 2 when it is caused to function as an anaerobic tank. For example, when the water surface of the anoxic tank 2 is set at about 5 m from the bottom, the sensor is preferably installed at about 2 to 3 m from the bottom.

If the oxidation-reduction potential detected at the boundary between the anoxic and anaerobic regions has started to increase extremely, it is suspected that the ascending speed of water mass due to the supply of sewage has completely exceeded the settling speed of activated sludge. In such cases, the anoxic tank 2 is returned to its normal operation state to mix the sewage and activated sludge. This ensures nitrogen removal performance and makes it possible to address any worsening of T-N concentration in the treated water before it happens.

The period in which the anoxic tank 2 is caused to function temporarily as an anaerobic tank and then resume its normal state does not need to be constant, and may be set by taking into account factors such as the inflow load conditions, quality of the water to be treated, and development state of actinomycetes. Any of the oxidation-reduction potential, T-N concentration, or MLSS may be used as an indicator, or these parameters may be used in combination as indicators.

Another embodiment of the organic wastewater treatment apparatus 100 is now described.

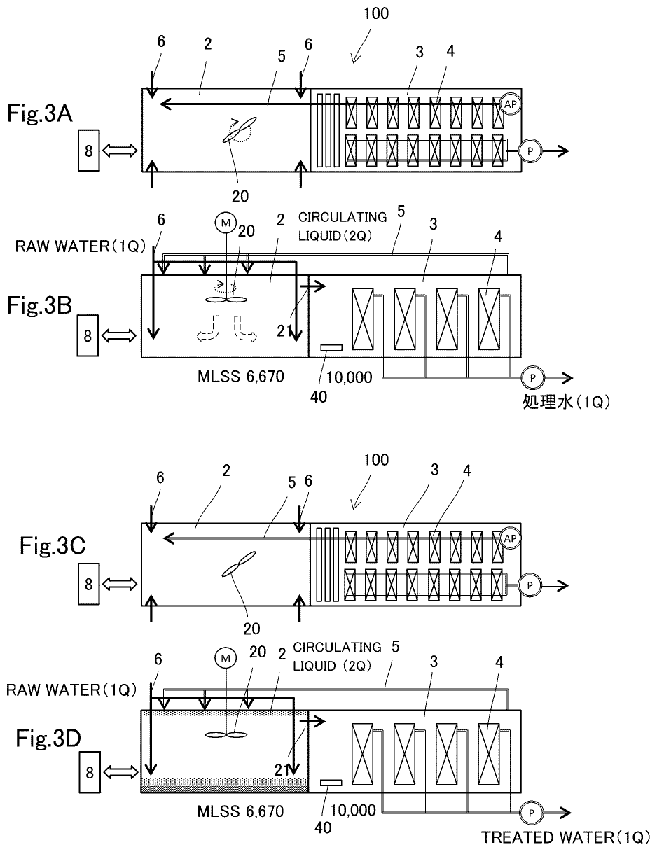

As shown in FIGS. 3A through 3D, the raw water supply mechanism 6 may be configured with multiple raw water supply pipes to supply raw water evenly toward the bottom of the anoxic tank 2, and the sludge return path 5 may be formed with branch pipes along its path to ensure that the return sludge from the sludge return path 5 is evenly returned to the anoxic tank 2 across its upstream and downstream regions. As the raw water supply mechanism 6, a raw water supply pipe with multiple openings formed in the pipe wall along the axial direction may be provided horizontally at the bottom of the anoxic tank 2.

With the anoxic tank 2 functioning as an anaerobic tank, the settling return sludge and the rising raw water are gently mixed with each other throughout the tank, making it possible to efficiently create anaerobic conditions that allow easily decomposable organic matters to be consumed.

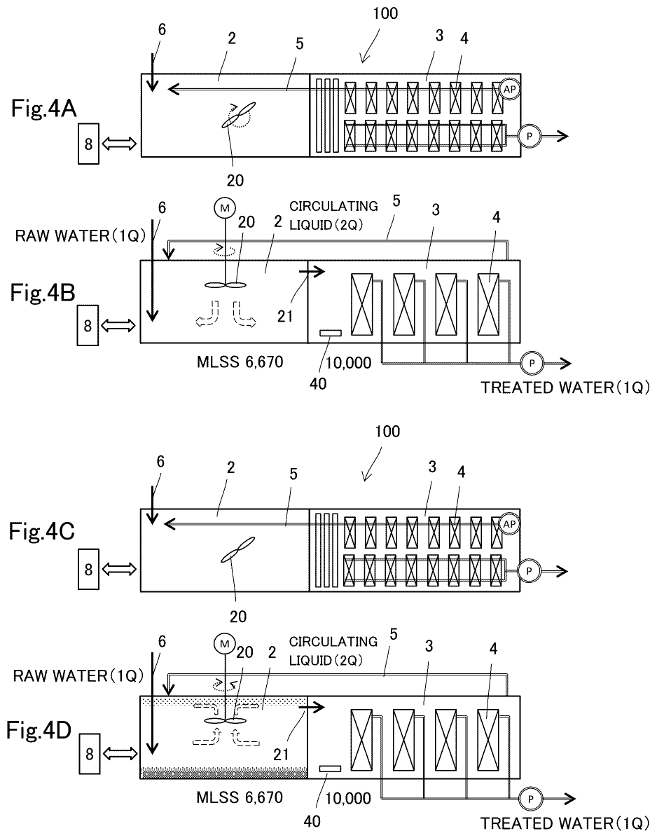

As shown in FIGS. 4A through 4D, when the control unit 8 switches the operating state of the stirring mechanism 20 in the anoxic tank 2 to cause it to temporarily function as an anaerobic tank, the motor M may be configured to rotate in a reverse direction at a lower speed than when it is rotating in a forward direction. In general, the shape of the stirring blades is designed to create a strong downflow when they are driven in a forward direction. Driving such stirring blades in a reverse direction does not create a significant upflow but merely creates a gentle upflow around the rotation axis, resulting in a gentle circulating flow in the upper layer region. As a result, the return sludge and the raw water are mixed with each other gently and evenly in the upper layer region of the tank, making it possible to efficiently create anaerobic conditions that allow easily decomposable organic matters to be consumed.

While the above embodiments have illustrated examples where the opening formed near the water surface of the anoxic tank 2 in the partition wall separating the anoxic tank 2 and the aerobic tank 3 serves as the communication portion 21, an overflow weir may be provided on the partition wall separating the anoxic tank 2 and the aerobic tank 3. This arrangement will increase the amount of sludge retained in the anoxic tank 2, but will also increase the power required to circulate the sludge.

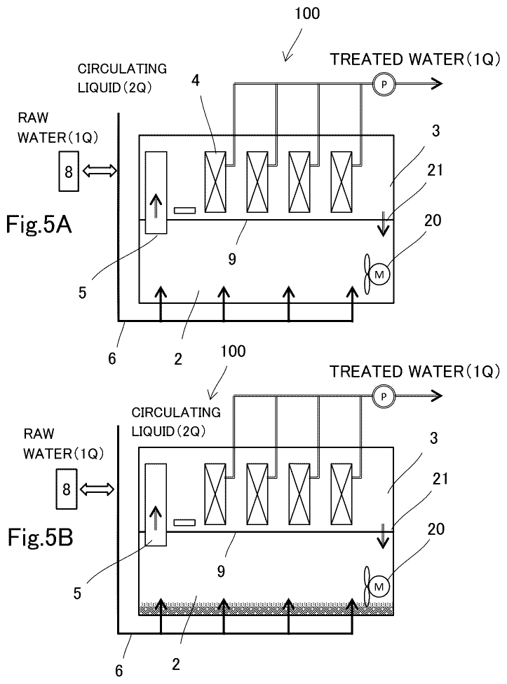

As shown in FIGS. 5A and 5B, the footprint of the apparatus 100 can be further reduced by providing a partition plate 9 to divide the treatment tank into upper and lower layers and using the lower layer as the anoxic tank 2 and the upper layer as the aerobic tank 3. An opening that defines the communication portion 21 may be formed at one end of the partition plate 9, and an air-lift pump that serves as the sludge return path 5 may be provided at the other end of the partition plate 9. Using a submersible mixer as the stirring mechanism 20 can facilitate denitrification reactions, and the nitrogen gas generated is released to the atmosphere through the sludge return path 5 and the aerobic tank 3.

In the case of a circulation MBR system designed for facilities that employ primary overflow water of general water quality as the raw water supplied to the anoxic tank 2, the surface loading of the anoxic tank is about 50 m/d relative to the maximum daily sewage volume. Thus, one might reasonably expect that, during times of low water inflow, a situation will occur where the settling speed of the sludge and the ascending speed of the sewage are in balance with each other. In this case, the capacity of the anoxic tank 2 may be 2 to 3 h in terms of HRT.

It will be appreciated that the above-described embodiments are only examples of the present invention. The above descriptions do not limit the present invention, and specific configurations of the elements may be modified as appropriate, as long as such modifications provide the functions and effects of the present invention as well. Also, some of the above-described embodiments may be combined as appropriate.

### Reference Signs List

2: Anoxic tank
3: Aerobic tank
4: Membrane separator
5: Sludge return path
6: Raw water supply mechanism
8: Control unit
9: Partition plate
20: Stirring mechanism
21: Communication portion
100: Organic wastewater treatment apparatus

1. An organic wastewater treatment method for biologically treating organic wastewater containing nitrogen in activated sludge, the method comprising:
switching an operating state of a stirring mechanism in an anoxic tank of an organic wastewater treatment apparatus to cause the anoxic tank to temporarily function as an anaerobic tank, wherein the organic wastewater treatment apparatus comprises:
the anoxic tank including the stirring mechanism, the stirring mechanism being configured to stir supplied raw water and activated sludge;
an aerobic tank including a membrane separator immersed in activated sludge; and
a sludge return path configured to return activated sludge from the aerobic tank to the anoxic tank.

2. The organic wastewater treatment method according to claim 1, further comprising adjusting a period in which the anoxic tank is caused to temporarily function as the anaerobic tank, using any of an oxidation-reduction potential, a T-N concentration, or an MLSS as an indicator.

3. An organic wastewater treatment apparatus for biologically treating organic wastewater containing nitrogen in activated sludge, the apparatus comprising:
an anoxic tank including a stirring mechanism, the stirring mechanism being configured to stir raw water and activated sludge;
an aerobic tank including a membrane separator immersed in activated sludge;
a sludge return path configured to return activated sludge from the aerobic tank to the anoxic tank; and
a control unit configured to switch an operating state of the stirring mechanism to cause the anoxic tank to temporarily function as an anaerobic tank.

4. The organic wastewater treatment apparatus according to claim 3, wherein
a raw water supply mechanism for supplying raw water to the anoxic tank is configured to supply raw water to near a bottom of the anoxic tank, and
the sludge return path is configured to return sludge from the aerobic tank to near a water surface of the anoxic tank.

5. The organic wastewater treatment apparatus according to claim 4, wherein a communication portion configured to allow activated sludge to flow down from the anoxic tank to the aerobic tank is located near the water surface of the anoxic tank.

6. The organic wastewater treatment apparatus according to claim 5, wherein the control unit is configured to adjust a period in which the anoxic tank is caused to temporarily function as the anaerobic tank, using any of an oxidation-reduction potential, a T-N concentration, or an MLSS as an indicator.

7. The organic wastewater treatment apparatus according to claim 6, wherein a potential sensor configured to measure the oxidation-reduction potential is located at a boundary between anoxic and anaerobic regions in the anoxic tank, the boundary being created when the anoxic tank is caused to temporarily function as the anaerobic tank.
